(19) United States
(12) Patent Application Publication
(10) Pub. No.: US 2021/0140218 A1
(43) Pub. Date: May 13, 2021

(54) ACTUATOR FOR A DAMPED RETURN DEVICE

(71) Applicant: MYPRO RESEARCH S.R.L., Thiene (VI) (IT)

(72) Inventor: Giancarlo BRUN, Thiene (VI) (IT)

(21) Appl. No.: 16/322,724

(22) PCT Filed: Jul. 19, 2017
(86) PCT No.: PCT/IB2017/054347

§ 371 Date: Feb. 1, 2019

(30) Foreign Application Priority Data
Aug. 3, 2016 (IT) 102016000081663

(51) Int. Cl. E05F 5/02

(52) U.S. Cl. CPC E05F 5/02

(57) ABSTRACT

The present invention concerns an actuator (12300) for a damped return device, in particular for doors or windows, comprising: a crank (3320); at least one fixing element (12360, 12361); a rotation seat (12350) of the crank having at least one cavity (12352, 12353) in a shape substantially complementary to that of at least one part of the fixing element (12360, 12361), wherein the fixing element (12360, 12361) is positioned between the crank (3320) and the rotation seat (12350).

### TECHNICAL FIELD OF THE INVENTION

The present invention concerns an actuator for a damped return device, in particular for doors or windows, and a respective damped return device.

### STATE OF THE ART

Doors and windows, or other similar movable elements, often need to be closed automatically, in particular in public places.

The automatic closing is generally obtained by means of an elastic element which can be constituted, for example, by a spring.

However, a simple spring has the defect of closing the door or the window too quickly, in particular during the last part of the closing movement, thus posing the risk of pinching the hands or other parts of the body of anyone in the vicinity of the door and/or window.

It is known that a damping device is generally used to solve this problem, wherein said device serves to damp the return action produced by the spring and thus reduce the closing speed of the door or window.

FIGS. 1A-1D show a damping device 1000 made according to the state of the art. In particular, FIGS. 1A and 1C show a side sectional view of the damping device 1000, while FIGS. 1B and 1D show sectional top views of the damping device respectively shown in FIGS. 1A and 1B.

In greater detail, the damping device 1000 comprises a piston 1100 that moves inside a cylinder 1200 containing a fluid 1210, for example oil.

The piston 1100 is provided with a cavity 1110 inside which there is an eccentric element 1310 of an actuator 1300.

When the actuator 1300 is rotated, the movement of the eccentric 1310 inside the cavity 1110 changes the rotary movement of the actuator 1300 into a linear movement of the piston 1100.

In particular, as can be seen in FIGS. 1C and 1D, a clockwise rotation of the actuator 1300 causes a movement of the piston 1100 towards the left.

In this manner, it is possible to change the rotary movement of the actuator 1300 into a linear movement of the piston 1100.

More particularly, this allows the actuator 1300 to be connected to the fulcrum of a door or a window which performs a rotary movement, and this rotary movement to be changed into a linear movement of the piston 1100.

At the same time, the movement of the piston 1100 is damped owing to the presence of the fluid 1210 inside the cylinder 1200.

In the figures, the fluid 1210 can flow from one side of the cylinder to the other through a passage 1260 created by the difference in size between the cross section of the cylinder 1200 and the cross section of the piston 1100.

Given the reduced size of the passage 1260, the movement of the fluid 1210 from one side of the piston 1100 to the other is slowed down, thus producing a damping effect.

However, the damping device 1000 poses several drawbacks.

In order to obtain the damping device 1000 it is necessary to place the piston 1100 inside the cylinder 1200.

This means that the cylinder 1200 must be made up of at least two separable portions, in particular a first body of the cylinder 1220 and a second body of the cylinder 1230.

These two portions need to be constructed very precisely from a mechanical point of view, in order to prevent any leakages of the fluid 1210 due to the imprecise coupling of said portions.

Even if a gasket 1240 is positioned between these two elements, the two bodies of the cylinder 1220 and 1230 must in any case be made very precisely, and this means increasing costs.

The same high level of precision is required also for the actuator 1300, which is coupled with the body of the cylinder 1230 through a gasket 1250.

Also in this case, the simple presence of the gasket 1250 cannot reduce the need to make the two elements 1300 and 1230 with high precision, and costs remain high.

Furthermore, the damping force of the damping device 1000 cannot be adjusted. More particularly, the resistance of the actuator 1300 to the movement of the door or window is given by the size of the passage 1260 and by the physical characteristics of the fluid 1210.

During use, the size of the passage 1260 cannot be modified and it is rather difficult to change the fluid 1210, since this operation requires that the device 1000 be opened.

This means that, in the case where different damping forces need to be used, the device 1000 must be made in different models, thus increasing production costs. Furthermore, if the actuator 1300 is positioned inside the body 1230 of the cylinder, the length of the body 1230 of the cylinder along the axis Z exceeds the length which is necessary to contain the piston 1100.

In other words, positioning the actuator 1300 inside the body 1230 of the cylinder makes it difficult to reduce the size of the device 1000.

In addition to the above, the actuator 1300 is necessarily arranged in a substantially central position in the damping device 1000.

This may not be the ideal solution, as the actuator should generally be placed at the level of the rotation point of the door or window, which is generally near the edge of the same, and this could not leave enough space for the damping device 1000.

Furthermore, the damping device 1000 is not provided with an elastic element suited to make the actuator return to its predetermined rest position. Therefore, an elastic element must be added on the outside of the device 1000, thus further increasing its size.

As an alternative to the above, it is possible to arrange an elastic element inside the element 1000, which however would make the production process more difficult, since also this elastic element needs to comply with very strict requirements in terms of mechanical tolerance and precision of the coupling with the body 1220, 1230 of the cylinder, in order to avoid any leakage of the fluid 1210.

Devices for automatically move or position windows or doors are known from documents U.S. Pat. No. 6,092,334 A, EP 1 959 079 A2 and GB 2 008 184.

### SUMMARY OF THE INVENTION

It is thus an object of the present invention to provide a damping device that is compact and/or easy to produce and/or economic to produce and/or suited to be modified in terms of damping characteristics during use, so that it can be adapted to different applications.

This object is achieved by means of an actuator according to the independent claims.

In particular, an embodiment of the present invention may concern a piston for a damping device, in particular for doors or windows, wherein the piston comprises a first half-piston and a second half-piston, wherein the piston is configured for use with a first half-cylinder and a second half-cylinder, wherein a first volume is included between the first half-piston and the first half-cylinder, wherein a second volume is included between the second half-piston and the second half-cylinder, and wherein the piston comprises a hole for the passage of a fluid between the first volume and the second volume.

Thanks to this embodiment, it is advantageously possible to obtain a piston that produces the damping effect owing to the presence of the passage created inside it.

This makes it possible to obtain a particularly compact damping device with a simplified construction structure.

A further embodiment of the present invention may concern a damping device, in particular for doors or windows, comprising: the piston according to the embodiment described above, the first half-cylinder and the second half-cylinder. Thanks to this embodiment, it is advantageously possible to obtain a compact damping device with a simplified construction structure.

In some embodiments, the damping device may also comprise: an adjusting needle configured to adjust the flow of the fluid through the hole.

Thanks to this embodiment, it is advantageously possible to control the damping action through the adjusting needle.

In some embodiments, the first half-piston may comprise a first thread, the first half-cylinder may comprise a second thread configured so that it can be screwed in the first thread, and/or the second half-piston may comprise a third thread, the second half-cylinder may comprise a fourth thread configured so that it can be screwed in the third thread.

Thanks to this embodiment, it is advantageously possible to damp a movement of the rotational type and change it into a linear movement damped by the damping device.

In some embodiments, a rotational movement of the piston with respect to the first half-cylinder and/or with respect to the second half-cylinder can be converted into a linear movement of the piston with respect to the first half-cylinder and/or with respect to the second half-cylinder through the interaction of the first and the second thread and/or through the interaction of the third and the fourth thread.

Thanks to this embodiment, it is advantageously possible to damp a movement of the rotational type and change it into a linear movement damped by the damping device.

A further embodiment of the present invention may concern a damped return device, in particular for doors or windows, comprising: a damping device according to any of the embodiments described above, an actuator configured in such a way as to move the piston with respect to the first half-cylinder and the second half-cylinder or configured in such a way as to move the first half-cylinder and/or the second half-cylinder with respect to the piston, and an elastic element configured in such a way as to bring the actuator back to a predetermined position, in the absence of forces exerted on the actuator.

Thanks to this embodiment, it is advantageously possible to obtain a particularly compact damped return device, in which only a limited number of components is in direct contact with the fluid, so as to simplify the production of the device and at the same time increase flexibility in the arrangement of the elements, and thus obtain many possible variant embodiments.

In some embodiments, the piston may comprise at least one contact surface configured so that it interacts with a contact surface of the actuator, or the first half-cylinder and/or the second half-cylinder may comprise at least one contact surface configured so as to interact with a contact surface of the actuator.

Thanks to this embodiment, it is advantageously possible to make the actuator act on the piston, or on one or both of the half-cylinders.

In some embodiments, the actuator may comprise a rod and a crank, and the rod may be configured in such a way that it moves the piston, or the rod may be configured in such a way that it moves the first half-cylinder and/or the second half-cylinder.

Thanks to this embodiment, it is advantageously possible to convert a movement of the rotational type of the door or window into a movement of the linear type, damped by the damping device.

In some embodiments, the elastic element may comprise a spring configured so that it acts on the rod.

Thanks to this embodiment, it is advantageously possible to cause the door or window to automatically return to a predetermined position, through the action of the spring on the rod.

In some embodiments, the elastic element may comprise a spring configured so that it acts on the piston or on the first half-cylinder and/or on the second half-cylinder.

Thanks to this embodiment, it is advantageously possible to cause the door or window to automatically return to a predetermined position, through the direct action of the spring on one of the elements of the damping device.

In some embodiments, the actuator and the elastic element may substantially be positioned on two opposite sides of the damping device.

Thanks to this embodiment, it is advantageously possible to obtain an elongated shape of the device, and therefore a very compact shape, at least in the two directions perpendicular to the longitudinal direction of the device.

A further embodiment of the present invention may concern an actuator for a damped return device, in particular for doors or windows, comprising: a crank, at least one fixing element, a rotation seat for the crank, provided with at least one cavity in a shape substantially complementary to that of at least one part of the fixing element, wherein the fixing element is positioned between the crank and the rotation seat.

Thanks to this embodiment, it is advantageously possible to guarantee that the actuator will be precisely placed in a predetermined position.

Furthermore, it is advantageously possible to facilitate the last part of the movement of the actuator towards that position.

A further embodiment of the present invention may concern an actuator for a damped return device, in particular for doors or windows, comprising: a crank, a rotation seat for the crank, at least one fixing element, wherein the crank is provided with at least one cavity in a shape substantially complementary to that of at least one part of the fixing element, wherein the fixing element is positioned between the crank and the rotation seat.

Thanks to this embodiment, it is advantageously possible to guarantee that the actuator will be precisely placed in a predetermined position.

Furthermore, it is advantageously possible to facilitate the last part of the movement of the actuator towards that position.

In some embodiments, the fixing element can be a ball or a roller, possibly drum-shaped.

Thanks to this embodiment, it is advantageously possible to facilitate the relative movement of the rotation seat and of the crank.

In some embodiments, the fixing element can have a triangular or generally polygonal cross section.

Thanks to this embodiment, it is advantageously possible to have a wide choice available regarding the specific shape of the fixing element.

In some embodiments, the fixing element can form a single body with the crank or with the rotation seat.

Thanks to this embodiment, it is advantageously possible to build the fixing element in the crank or in the rotation seat, thus reducing the number of separate components of the actuator.

In some embodiments, the crank can unload at least part of its weight and/or of a weight acting on it on the rotation seat, through the fixing element in at least one relative position of the crank and the rotation seat.

Thanks to this embodiment, it is advantageously possible to cause the crank to rotate with respect to the rotation seat in the moment when said weight pushes the fixing element inside the respective cavity.

In some embodiments, the fixing element can be placed in the cavity, with the actuator in a predetermined position, preferably in the rest position.

Thanks to this embodiment, it is advantageously possible to define with precision the rest position of the actuator, corresponding for example to the open or closed position of a door or a window.

A further embodiment of the present invention may concern a damped return device, in particular for doors or windows, comprising: an actuator according to any of the embodiments described above;

a damping device activated by the actuator; an elastic element configured so as to bring the actuator back to a predetermined position, in the absence of a force exerted by the actuator.

Thanks to this embodiment, it is advantageously possible to obtain a particularly compact damped return device, with the advantage of being able to guarantee the precise positioning of the actuator, and therefore of the damped return device, in a predetermined position, even without requiring excessive force to be exerted by the elastic element.

Furthermore, it is advantageously possible to facilitate the last part of the movement of the actuator towards that position, also in this case reducing the specifications of the force applied by the elastic element.

In some embodiments, the actuator may furthermore comprise a rod and this rod can be configured in such a way as to move the damping device.

Thanks to this embodiment, it is advantageously possible to convert a movement of the rotational type of the door or window into a movement of the linear type, damped by the damping device.

### BRIEF LIST OF THE DRAWINGS

Further characteristics and advantages of the invention will be highlighted in greater detail through the analysis of the following detailed description of some preferred but not exclusive embodiments, illustrated by way of indicative and not limiting example with the support of the attached drawings.

In the drawings, the same reference numbers identify the same components.

In particular:

FIG. 1A shows a schematic sectional side view, taken along line A-A of FIG. 1B, of a damping device 1000 made according to the start of the art;

FIG. 1B shows a schematic sectional top view, taken along line B-B of FIG. 1A, of the damping device 1000 shown in FIG. 1A;

FIG. 1C shows a schematic sectional side view, taken along line C-C of FIG. 1D, of the damping device 1000 shown in FIG. 1A, in a different position;

FIG. 1D shows a schematic sectional top view, taken along line D-D of FIG. 1C, of the damping device 1000 shown in FIG. 1C;

FIG. 2A shows a schematic exploded three-dimensional view of a damping device 2000 according to an embodiment of the present invention;

FIG. 2B shows a schematic three-dimensional view of the damping device 2000 of FIG. 2A when assembled;

FIG. 2C shows a schematic sectional side view, taken along line C-C of FIG. 2D, of the damping device 2000 shown in FIG. 2A when assembled;

FIG. 2D shows a schematic sectional top view, taken along line D-D of FIG. 2C, of the damping device 2000 shown in FIG. 2A when assembled;

FIG. 3 shows a schematic sectional side view of a damped return device 3000 according to an embodiment of the present invention;

FIG. 4A shows a schematic three-dimensional view of an actuator 3300 according to an embodiment of the present invention;

FIGS. 4B and 4C show schematic three-dimensional views of parts of an actuator 3300 according to alternative embodiments of the present invention;

FIG. 5A shows a schematic sectional side view, taken along line A-A of FIG. 5B, of parts of a damped return device 3000 made according to an embodiment of the present invention;

FIG. 5B shows a schematic sectional top view, taken along line B-B of FIG. 5A, of the parts of the damped return device 3000 shown in FIG. 5A;

FIG. 5C shows a schematic sectional side view, taken along line C-C of FIG. 5D, of the parts of the damped return device 3000 shown in FIG. 5A in a different position;

FIG. 5D shows a schematic sectional top view, taken along line D-D of FIG. 5C, of the parts of the damped return device 3000 shown in FIG. 5C;

FIG. 6A shows a schematic sectional side view, taken along line A-A of FIG. 6B, of parts of a damped return device 3000 made according to an embodiment of the present invention;

FIG. 6B shows a schematic sectional top view, taken along line B-B of FIG. 6A, of the parts of the damped return device 3000 shown in FIG. 6A;

FIG. 7A shows a schematic three-dimensional view of a possible use of a damped return device 3000 according to an embodiment of the present invention;

FIG. 7B shows an enlarged schematic three-dimensional view of parts of FIG. 7A;

FIG. 8 shows a schematic three-dimensional view of a possible use of a damped return device 10000 according to an embodiment of the present invention;

FIG. 9 shows a schematic three-dimensional view of a damped return device 10000 according to an embodiment of the present invention;

FIG. 10 shows a schematic exploded three-dimensional view of a damping device 9000 according to an embodiment of the present invention and of parts of the damped return device 10000 shown in FIG. 9;

FIG. 11A shows a schematic sectional side view, taken along line A-A of FIG. 11B, of parts of the damping device 10000 shown in FIG. 9;

FIG. 11B shows a schematic sectional top view, taken along line B-B of FIG. 11A, of the parts of the damped return device 10000 shown in FIG. 11A;

FIG. 11C shows a schematic sectional top view of the parts of the damped return device 10000 of FIG. 11A, in a different position;

FIG. 12A shows a schematic sectional side view of parts of a damped return device 12000 according to an embodiment of the present invention;

FIG. 12B shows a schematic three-dimensional view of an actuator 12300 according to an embodiment of the present invention;

FIG. 12C shows a schematic sectional side view of parts of the damped return device 12000 of FIG. 12A, in a different position;

FIG. 13 shows a schematic exploded three-dimensional view of a damped return device 13000 and of an actuator 13300 according to embodiments of the present invention;

FIG. 14A shows a schematic side view of a damped return device 14000 according to an embodiment of the present invention;

FIG. 14B shows a schematic sectional top view, taken along line B-B of FIG. 14A, of the damped return device 14000;

FIG. 15 shows schematic sectional side views of fixing elements according to different embodiments of the present invention.

### DETAILED DESCRIPTION OF THE INVENTION

A damping device 2000 according to a first embodiment of the present invention is schematically illustrated in FIGS. 2A-2D.

The damping device 2000 comprises a piston 2500 comprising a first half-piston 2510 and a second half-piston 2511.

In particular, as illustrated, the first half-piston 2510 and the second half-piston 2511 are connected to each other by a body whose cross section is generally larger than that of the half-pistons 2510 and 2511 and has at least one contact surface 2560, 2561 described here below. More generally, it is not necessary for the part of the piston between the first half-piston 2510 and the second half-piston 2511 to have a larger cross section than the half-pistons 2510, 2511, but it is sufficient that it be configured in such a way as to allow the movement of the piston to be controlled, for example providing a contact surface in the shape of an external ring, as in the case illustrated in the figure, or in the shape of an internal ring, or in any shape suited to allow a force to be exerted on the piston, in at least one longitudinal direction of the same.

The damping device 2000 furthermore comprises a first half-cylinder 2410 and a second half-cylinder 2420.

In this way, as can be seen in FIGS. 2C and 2D, it is possible to define a first volume 2430 included between the first half-piston 2510 and the first half-cylinder 2410 and a second volume 2440 included between the second half-piston 2511 and the second half-cylinder 2420.

The first volume 2430 and the second volume 2440 contain a fluid 1210. The passage of the fluid 1210 between the first volume 2430 and the second volume 2440 is allowed by a hole 2550 made through the piston 2500.

The size of the hole 2550 and the physical characteristics of the fluid 1210 define the damping force of the damping device 2000.

In addition to the above, optionally, a hole 2542 is made in the piston 2500 in such a way as to allow the introduction of an adjusting needle 2540. The length of the adjusting needle 2540 is such as to allow the latter to reach the hole 2550, as can be seen for example in FIG. 2C.

Thus, by screwing or unscrewing the adjusting needle 2540 it is possible to modify the cross section of the hole 2550 through which the fluid 1210 flows.

In this way, thanks to the adjusting needle 2540, it is advantageously possible to adjust the damping force of the damping device 2000, even after its production, with no need to open it.

In the embodiment illustrated in FIG. 2A, the damping device 2000 furthermore comprises four gaskets 2520-2523 arranged in four corresponding gasket seats 2530-2533, in such a way as to prevent the fluid 1210 from flowing out of the damping device 2000.

However, it will be clear that the number of gaskets is not limited to that illustrated herein and, for example, the damping device 2000 can be made with two gaskets only, specifically one on the first half-piston 2510 and one on the second half-piston 2511.

In some embodiments, furthermore, it is possible to omit the gaskets, increasing precision in the manufacture of the half-pistons 2510, 2511 and the half-cylinders 2410, 2420.

In addition to the above, in the embodiment illustrated in FIG. 2A, a gasket 2541 is also provided in order to prevent any leakage of the fluid 1210 between the hole 2542 and the adjusting needle 2540.

It will be clear that, also in this case, the number of gaskets can vary or that there may even be no gaskets at all.

The damping device 2000 is advantageous compared to the know art, since it requires a limited number of components having rather low production tolerances in order to avoid any leakage of the fluid 1210.

In particular, only the half-pistons 2510, 2511 and the two half-cylinders 2410 and 2420 and, where present, the optional adjusting needle 2540 require a high level of manufacturing precision.

Compared to the damping device 1000, in the damping device 2000, therefore, it is not necessary to make the actuator 1300 with such a level of mechanical precision.

This is particularly advantageous, as the actuator 1300 is a component that has a complex mechanical structure and its production with such tolerances as to guarantee tightness against any leakage of the fluid 1210 is very complicated.

In the damping device 2000, only the half-cylinders 2410 and 2420 the half-pistons 2510 and 2511 need such a level of mechanical precision. This is particularly advantageous, since these components can be made, for example, with a substantially circular cross section which can easily have the precision level required to prevent leakages of the fluid 1210.

Other parts of the device 2000 like, for example, the part of the piston 2500 included between the first half-piston 2510 and the second half-piston 2511, or like the hole 2550, do not require such a level of mechanical precision.

The construction of the damping device 2000 is thus simpler and more economic than the construction of the device 1000.

Furthermore, the quantity of elements that are in contact with the fluid 1210 is reduced.

In some cases, the chemical-physical chracteristics of the elements in contact with the fluid 1210 require special considerations in terms of compatibility.

By reducing the number of elements in contact with the fluid 1210, it is advantageously possible to reduce the number of elements that have to comply with these characteristics.

In addition to the above, the volume occupied by the fluid 1210 can be reduced with respect to that occupied in the damping device 1000, which results in a more compact shape of the damping device 2000 and in a smaller quantity of fluid 1210 used, thus reducing also the related costs.

Furthermore, the damping device 2000 can be applied to different types of actuators and is not limited, as in the case of the damping device 1000, to an actuator with a fixed size and necessarily of the rotational type. On the contrary, the damping device 2000 can work with an actuator of the linear and/or rotational type, as described here below.

Furthermore, all of the external elements of the damping device 2000, such as, for example, the actuator 3300 and the elastic element 3600 which are described below, do not need to be made with the same level of mechanical precision and/or with the same materials as the damping device.

For example, with reference to the damped return device 3000 illustrated in FIG. 5A-6B, the frame 3700 can be made of plastic.

FIG. 3 shows a damped return device 3000 comprising the damping device 2000, an actuator 3300 and an elastic element 3600. The actuator 3300 and the elastic element 3600 are illustrated only schematically. Specific embodiments of these two elements are described in greater detail below.

The actuator 3300 is generally configured in such a way as to move the piston 2500 with respect to the first half-cylinder 2410 and the second half-cylinder 2420.

More generally, the actuator 3300 can act on one of the half-cylinders 2410, 2420 or on the piston 2500.

In any case, it is sufficient that the actuator 3300 acts on one of the elements of the damping device 2000, thus producing a relative movement of the piston 2500 with respect to the half-cylinders 2410, 2420.

In the case illustrated in the figure, the actuator 3300 acts on the first half-cylinder 2410, thus changing the relative position of the latter with respect to the piston 2500.

The elastic element 3600 is configured in such a way as to bring the actuator 3300, or the damping device 2000, back to a predetermined position, in the absence of forces exerted on the actuator 3300.

In particular, in the example shown in FIG. 3, the elastic element 3600 acts on the second half-cylinder 2420.

In a possible embodiment, the actuator 3300 can be configured so as to exert a thrusting action in the positive direction X, for example when a door opens, and the elastic element 3600 can be configured so as to produce an elastic return action in the negative direction X and thus cause the door to close. In the absence of a force exerted by the actuator 3300, the elastic element 3600 will thus tend to make the half-cylinder 2420 move in the negative direction X, moving the fluid 1210 through the hole 2550 and in this way producing a movement of the actuator 3300 in the negative direction X until reaching a predetermined rest position, for example corresponding to the closed condition of the door.

FIG. 4A shows in greater detail a specific embodiment of an actuator 3300 according to the present invention.

In particular, the actuator 3300 comprises a rod 3330 and a crank 3320. In this way, it is possible to change a movement of the rotational type into a linear movement.

This is particularly advantageous, since it makes it possible to position the damped return device 3000 in proximity to the fulcrum of a door or a window, wherein said door or window performs a movement of the rotational type.

More specifically, the operation of the crank 3320 is substantially similar to that of the actuator 1300.

In particular, the crank 3320 comprises an eccentric 3310 and a connection element 3340 which is illustrated only schematically.

The connection element 3340 can, in general, have any shape and/or any characteristics that allow it to be connected to a door or a window.

The eccentric 3310 cooperates with a seat 3331 made in the rod 3330, in such a way as to change the rotational movement of the crank 3320 into a linear movement of the rod 3330.

The shape of the rod 3330 is at least partially complementary to that of the piston 2500.

In particular, the rod 3330 comprises at least one contact surface 3332 configured in such a way as to cooperate with the at least one contact surface 2560, 2561 of the piston 2500.

By rotating the crank 3200, it is thus possible to move the rod 3330 along the direction X, thus causing the piston 2500 to move.

In particular, FIGS. 5A and 5B show the rod 3330, the crank 3320 and the piston 2500 in a first extreme position in the negative direction X, while the FIGS. 5C and 5D represent these elements in a second extreme position in the positive direction X.

As can be seen in the figures, the relative position of the half-cylinders 2410, 2420 with respect to the crank 3320 is fixed by a frame 3700.

On the contrary, the piston 2500 can move with respect to the half-cylinders 2410, 2420 and with respect to the crank 3320.

When the crank 3320 is rotated, the movement transmitted by the crank 3320 to the rod 3330 is thus changed into a linear movement of the piston 2500. The rotation of the crank 3320 is thus damped by the damping effect produced by the movement of the piston 2500 between the two half-cylinders 2410 and 2420. FIGS. 6A and 6B schematically show a possible embodiment of the elastic element 3600.

In particular, the elastic element 3600 is constituted by a spring included in the frame 3700 and acting on the opposite end of the rod 3330 with respect to the side where there is the crank 3320.

In this way, the spring produces an elastic return force in the negative direction X, so as to bring the rod 3330 and the crank 3320 back to the position illustrated in FIG. 5A, in the absence of other forces exerted on the crank 3320. It will be clear that in alternative embodiments the elastic element 3600 can also act directly on the element to be moved, in the case at hand the piston 2500, thus avoiding the action of the rod 3330.

In the embodiment illustrated herein there is also an optional preload element 3610.

The preload element 3610 makes it possible to adjust the elastic return force of the elastic element 3600, in such a way as to be advantageously able to configure the damped return device 3000 for different applications.

In the embodiment described herein, the piston 2500 is moved by the rod 3330, while the half-cylinders 2410, 2420 are fixed with respect to the frame 3700.

The cooperation between the rod 3300 and the piston 2500 can be better understood by referring to the view shown in FIG. 4B.

However, it is clear that also the opposite solution can be implemented. In particular, as schematically shown in FIG. 4C, the piston 2500 can be fixed with respect to the frame, for example owing to the interaction between the contact surface 2561 of the piston 2500 and a corresponding cavity in the frame 3700, while the rod 3330 can move the half-cylinders 2410, 2420.

The same applies also to the other embodiments illustrated here below.

As a further alternative, the rod 3330 can move even one of the half-cylinders 2410, 2420 only, for example the half-cylinder 2410, while the other half-cylinder 2420 is moved by the elastic element 3600 which therefore can act directly on the half-cylinder 2420 instead of on the rod 3330.

It will be clear that, in this case, the return of the actuator to its rest position can be however guaranteed by the elastic element 3600 which, through its action on the half-cylinder 2420, moves the fluid 1210 causing the movement of the half-cylinder 2410 and the consequent movement of the rod 3330 and of the actuator. A possible use of the damped return device 3000 is illustrated in relation to the window 7000 shown in FIG. 7A and in the enlarged view of FIG. 7B.

However, it will be clear that the present invention is not limited to the specific use illustrated herein.

In particular, the window 7000 schematically comprises a frame 7001 and a window leaf 7002 which can be opened and closed with respect to the frame 7001.

The movement of the portion of the window leaf 7002 hinged to the frame 7001 is of the rotary type.

It is thus possible to connect the rotation axis of the window leaf 7002 to the connection element 3340 of the damped return device 3000, as schematically shown.

Since the actuator 3300 and the elastic element 3600 are substantially arranged on two opposite sides of the damping device 2000, it is possible to obtain a damped return device 3000 in a substantially narrow and elongated shape.

Thanks to this shape, it is advantageously possible to introduce the damped return device 3000 in a hole made in the frame 7001.

Furthermore, since the actuator 3300 and the elastic element 3600 are physically separated from the hydraulic part containing the damping device 2000, they can be positioned and more generally configured advantageously according to the type of use, without requiring a modification of the damping device 2000. Furthermore, in those embodiments including it, the adjusting needle 2540 and/or the preload element 3610 can be easily accessed by opening the window leaf 7002.

It is thus advantageously possible not only to configure the damped return device 3000 for different uses, but also to adjust it even after its installation.

This, among the other things, makes it possible to compensate for any variations in the damping characteristics due, for example, to the ageing of the fluid 1210 and/or to different conditions of use such as, for example, different operating temperatures, different weights of the window leaf 7002, etc.

FIG. 8 shows a possible use of a damped return device 10000 carried out according to a further embodiment of the present invention, in combination with a window 8000.

In particular, differently from the damped return device 3000, the damped return device 10000 can be installed like a hinge on the vertical part of the frame 8001. FIG. 9 shows an enlarged view of the damped return device 10000.

In particular, the device is shown in the open condition, in order to make it easier to understand how it works.

As can be seen in FIG. 9 and in the FIGS. 10 and 11A-11C, the damped return device 10000 comprises an actuator 10300, a damped return device 9000 and an elastic element 10600.

In this case, the actuator 10300 acts rotating the piston 9500 with respect to the half-cylinders 9410 and 9420.

As described below, the rotation of the piston 9500 with respect to the half-cylinders 9410, 9420 causes a linear movement of the piston 9500 with respect to the half-cylinders 9410, 9420, thus producing a damping force, as previously described.

Furthermore, it should be clear that also the symmetrical solution can be implemented, in which the piston is fixed and the half-cylinders 9410, 9420 rotate.

In both cases, the rotation of either the piston 9500 or the half-cylinders 9410, 9420 causes the rotational movement to be changed into a linear movement, which is damped as described above.

More specifically, as can be seen in FIG. 10, the half-piston 9510 comprises a thread 9511 cooperating with a thread, not visible in the figure, located inside the half-cylinder 9410.

In a similar manner, the half-piston 9520 comprises a thread 9521 cooperating with a thread 9422 located inside the half-cylinder 9420.

In order to avoid the rotation of the half-cylinders 9410 and 9420, these are provided with contact surfaces 9411 and 9421 cooperating with corresponding contact surfaces of the frame 10700, as schematically illustrated, for example, in FIGS. 9 and 11A.

The half-cylinders 9410 and 9420 are thus integral with the window leaf 7002. The actuator 10300 comprises a contact surface 10332 configured in such a way as to cooperate with a contact surface 9560 of the piston 9500.

In general, however, it will be sufficient to make sure that the actuator 10300 is integral with the piston 9500.

This can be obtained, for example, by screwing the two elements together or using other similar connection systems.

In the moment when the actuator 10300 causes a rotation of the piston 9500, the damping force produced by the linear movement of the piston 9500 with respect to the half-cylinders 9410, 9420 is thus changed into a damping force affecting the rotation of the piston 9500 and consequently affecting the rotation of the actuator 10300 with respect to the window leaf 7002.

In the embodiment illustrated herein, similarly to what happens in the case of the damping device 2000, there is an optional adjusting needle 2540 which is introduced in the hole 2542 of the piston 9500, through an apposite hole 10333 made in the actuator 10300.

As described above, the invention can also be implemented without this element. Furthermore, even if in this case four gaskets 2350-2353 are shown, it will be clear that the present invention is not limited to this specific number of gaskets and, as previously described, the invention can be implemented even without gaskets.

The operation of the damped return device 10000, and in particular of the elastic element 10600, is described with reference to FIGS. 11A-11C.

In particular, FIGS. 11A and 11B show the damped return device 1000 in the open condition of the device, meaning with the window leaf 7002 open, while FIG. 11C shows the damped return device 10000 in the closed condition.

As can be seen in FIGS. 11A and 11B, in the open condition the actuator 10300 pushes against a loading device 10640 in such a way as to bend one or more elastic blades 10620 against a fulcrum 10630 integral with the frame 10700 of the damped return device 10000.

This movement bends the blades 10620, which thus have an elastic return force. In other words, the distance D1 shown in FIGS. 11A and 11B is shorter than the distance D2 shown in FIG. 11C.

This means that the loading device 10640 produces an elastic return force in the negative direction X.

It is clear that a similar result can in any case be obtained with elastic elements having different configurations, for example with a helical spring positioned between the fulcrum 10630 and the actuator 10300.

It is clear, furthermore, that according to the embodiment described the spring is in a substantially loaded position when the damped return device 10000 is aligned, or in the condition illustrated in FIG. 11B, while the spring is in a substantially unloaded position when the damped return device 10000 is at right angles, as illustrated in FIG. 11C.

However, the invention is not limited to this configuration and the opposite may be obtained by specifically modifying the shape of the actuator 10300.

In particular, the actuator 10300 may be in a shape according to which D1 exceeds D2, that is the opposite situation to that illustrated.

In this case, the damped return device 10000 would be substantially unloaded in the aligned position of FIG. 11B and substantially loaded in the position at right angles of FIG. 11C.

In the embodiment illustrated, the elastic return force, together with the shape of the actuator 10300, causes, in the absence of other forces exerted on the actuator 10300, the return of the damped return device 10000 from the position shown in FIG. 11B to the position shown in FIG. 11C.

This can be obtained, for example, through a substantially semi-elliptical shape of the actuator 10300 extending more in direction X than in direction Z from the centre of the ellipse. More generally, it will be sufficient that the shape of the actuator 10300 is such that in the open condition the actuator 10300 positions the loading device 10640 nearer to the fulcrum 10630 than in the closed condition. The specific shape of the actuator 10300, therefore, can be not only substantially semi-elliptical, in fact also segmented shapes such as, for example, a semi-hexagonal shape, can be implemented.

This furthermore gives the opportunity to obtain several substantially stable positions of the damped return device 10000.

In the embodiments described above, the damping device performs a linear movement and the actuator generally changes a movement of the rotational type into the linear movement of the damping device.

This advantageously makes it possible to use the actuator at the level of a rotation point of a door or a window opening by rotation.

However, the present invention is not limited to this embodiment. In some embodiments, in the case of sliding doors or windows or in the case of doors or windows opening with an at least partially linear movement, it will be possible to connect the damping device directly to the door or window, in the absence of an actuator converting a rotary movement into a linear movement.

With reference, for example, to the damped return device 3000, it will be possible to connect the door or window to the piston 2500 directly or through a rod 3330, also in the absence of the crank 3320.

It should be noted that, in these cases, the operating length of the damping device must not necessarily correspond to the entire length covered by the sliding movement of the door or window.

This can be possibly obtained by increasing the operating length of the damping device.

However, the present invention is not limited to this case. In some cases, for example, it will be possible to make the damping device work only during the last part of the stroke of the door or window. In other cases, for example, a damping device can be provided on the opening side of the door or window, so as to damp the opening movement in its final part, and a further damping device on the closing side of the door or window, so as to damp the closing movement in its final part.

Again, in addition to or as an alternative to the above, since the elastic element 3600, 10600 needn't necessarily be an inner part of the damping device 2000, 9000, it will be possible to arrange the elastic element in such a way that it acts on the door or window in another position, separate from that of the damping device.

In this case, the elastic element moves the door or the window which, in turn, moves the damping device.

Also in this case, therefore, through the door or window, the elastic element can be used to bring the damping device back to a predetermined rest position. FIGS. 12A, 12B and 12C schematically show another embodiment of the present invention.

In particular, as can be seen in FIG. 12B, an actuator 12300 according to an embodiment of the present invention differs from the actuator 3300 described above owing to the presence of two fixing elements 12360 and 12361, which in the specific embodiment illustrated herein are in the shape of small balls.

The actuator 12300 differs from the actuator 3300 also owing to the presence of a rotation seat 12350 provided with two cavities 12352, 12353 whose shape is substantially complementary to the shape of at least one part of the fixing elements 12360, 12361.

In particular, in the embodiment illustrated, the two cavities 12352, 12353 have a substantially hemi-spherical shape, so that they can accommodate approximately one half of each fixing element 12360, 12361.

In a preferred embodiment, the rotation seat 12350 furthermore comprises a race 12351 whose thickness is smaller than that of the rotation seat 12350, so as to direct the movement of the fixing elements 12360, 12361, as described below. However, in the following description it is clear that, even if the presence of the race 12351 is advantageous, as it makes it possible to prevent the two fixing elements 12360, 12361 from accidentally moving out of their seats, the present invention is not limited to embodiments provided with the race 12351.

In the embodiment illustrated herein, furthermore, the rotation seat 12350 is provided with a contact surface 12354 so that, once the rotation seat 12350 has been inserted in the frame 3700, the rotation seat 12350 is fixed with respect to the frame 3700 due to the interaction between the contact surface 12354 and a corresponding inner surface of the frame 3700.

This embodiment offers the advantage that it can prevent the movement of the rotation seat 12350 in a simple manner.

However, the present invention is not limited to the embodiment illustrated above.

In alternative embodiments, for example, it will be possible to prevent the movement of the rotation seat 12350 by screwing it or welding it to the frame 3700 and/or using glue, or making the rotation seat 12350 as an integral part of the frame 3700.

The crank 3320 of the actuator 12300 comprises also two seats for the fixing elements 12360, 12361, better visible in FIG. 12A.

The shape of the two seats is substantially similar to that of the cavities 12352 and 12353 and therefore the two seats make it possible to introduce substantially one half of each fixing element 12360, 12361 in the crank 3320.

In the rest position illustrated in FIG. 12A, possibly corresponding to the closed condition of the door or window connected to the actuator 12300, the fixing elements 12360, 12361 are positioned inside the cavities 12352, 12353.

In the moment when the actuator 12300 starts rotating, so as to reach an intermediate position like that shown in FIG. 12C, the two fixing elements 12360, 12361 are forced out of the cavities 12352 and 12353 by the rotary movement of the actuator 12300.

In the case illustrated in the figure, where the two fixing elements 12360, 12361 are balls, in order to ensure that the balls remain inside the respective seats in the crank 3320 and move out of the cavities 12352, 12353, it is possible to make the seats in the crank, in such a way that a larger volume of the balls is contained in the crank 3320 compared to the volume contained in the cavities 12352, 12353. As an alternative, in the embodiment illustrated, the presence of the race 12351 can facilitate the movement of the balls with respect to the rotation seat 12350 rather than with respect to the crank 3320.

In alternative embodiments, the cavities 12352 and 12353 can be slightly larger than the balls, while the respective seats in the crank 3320 can have a size more similar to that of the balls, in such a way as to facilitate the movement of the balls out of the cavities provided in the rotation seat 12350 and not out of the respective seats in the crank 3320.

The movement of the fixing elements 12360, 12361 out of the seats 12352, 12353 causes an upward movement, in the positive direction Y, of the crank 3320, as illustrated in FIG. 12C.

In the moment when there is no force acting on the actuator, for example when there is no force opening the door or window, the elastic element 3600 tends to bring the actuator 12300 back towards the position illustrated in FIG. 12A.

The presence of the fixing elements 12360 and 12361 guarantees the precise positioning of the actuator 12300 in a predetermined position.

In particular, in the moment when the fixing elements 12360 and 12361 approach the respective cavities 12352 and 12353, the weight exerted by the door or window on the crank 3320 tends to push the crank 3320 downwards, thus pushing the fixing elements in the respective cavities and thus achieving the precise positioning of the actuator 12300.

Furthermore, this solution offers the advantage that the last part of the return movement of the actuator 12300 towards its rest position can be facilitated and/or substantially performed through the sliding movement of the fixing elements 12360 and 12361 into the respective cavities, as an addition to and/or instead of the force transmitted by the elastic element 3600.

This is particularly advantageous, as it makes it possible to have an elastic element 3600 with reduced elastic force.

In other words, it is not necessary for the elastic force of the elastic element 3600 to be so high as to guarantee the return of the actuator 12300 to the most stretched condition of the elastic element 3600, corresponding to the rest position of the actuator 12300.

In this case, if the elastic element is already capable of providing such a force when it is in its most stretched position, it may be difficult to compress the elastic element during the rotation of the actuator.

The embodiment described above advantageously resolves this problem and requires less effort by the user of the damped return device 12000 when opening the door or window.

FIG. 13 schematically shows an alternative embodiment of the present invention.

In particular, in the embodiment shown in FIG. 13 the damped return device 13000 comprises an actuator 13300 that differs from the actuator 12300 of FIG. 12A-C due to the different shape of the crank 13320. In particular, as can be seen, the crank 13320 is provided with a cavity inside which it is possible to introduce a corresponding element of the door or window instead of the connection element 3340.

Furthermore, the damped return device 13000 differs from the damped return device 12000 in that it exploits the advantageous effect of the fixing elements 12360 and 12361 in combination with a damped return device similar to the damped return device 1000 of FIGS. 1A-1D.

This clarifies, therefore, that the advantages obtained from the embodiment comprising the fixing elements 12360, 12361 are not limited to a specific form of the damped return device, but can be applied to different types of damped return devices.

In particular, in the case of the damped return device 13000, the actuator 13300 does not act on a rod but acts directly on the piston 1100, inserted in a respective cavity defined by the bodies 1220 and 1230 of the cylinder, inside which there is also a spring serving as elastic element 3600. The closing of the two bodies 1220 and 1230 of the cylinder is guaranteed by the presence of several screws 13273. In the embodiment illustrated there are also two closing elements 13270 and 13271, between which a gasket 1250 is inserted in such a way as to avoid any leakage of the fluid 1210.

A further alternative embodiment of the present invention is schematically illustrated in FIGS. 14A and 14B.

In particular, a damped return device 14000 is illustrated. The damped return device 14000 differs from the damped return device 13000 in that it can be positioned over the door or window and not under the door or window.

More specifically, the actuator 14300 is provided with a hole 14321 inside the crank 14320, which allows said door or window to be coupled with the crank 14320, thus unloading the weight of the same on the crank 14320.

The crank 14320 is furthermore provided with a head 14322, which in the figure is substantially T-shaped and under which the fixing elements 12360, 12361 are positioned.

In FIG. 14A, for the sake of clarity, the rotation seat 12350 is represented as in a sectional view, so that it is easier to understand the operation of the damped return device 14000.

Also in this case, the fixing elements 12360, 12361 are thus in an intermediate position between the rotation seat 12350 and at least one part of the crank 14320, in particular the head 14322 of the same.

Also in this embodiment, therefore, it is possible to unload the weight supported by the crank 14320 on the rotation seat 12350 through the fixing elements 12360, 12361.

Even if in the embodiments illustrated in FIGS. 12A-14B the diameter of the rotation seat is substantially similar to that of the crank, the present invention is not limited to this embodiment.

In alternative embodiments, for example, the rotation seat may be a ring with larger diameter than the crank, provided with a hole whose diameter is substantially equal to that of the crank, so as to allow the insertion of the crank in the rotation seat.

In this case, the crank may be provided with a collar with diameter substantially equal to that of the rotation seat, in such a way as to allow the fixing elements 12360 and 12361 to be positioned between said collar and the rotation seat.

Even if in the embodiments illustrated there are two fixing elements 12360, 12361, the present invention is not limited to this form of embodiment.

In particular, by providing at least two fixing elements 12360, 12361 it is possible to unload the weight acting on the crank in a symmetrical manner. However, the number of fixing elements may also be higher than two. Alternatively, even one fixing element only may be sufficient, as the position of the axis of the actuator can in any case be guaranteed by the positioning of the actuator itself inside its seat and/or by the integral connection of the actuator with the door or window.

Even if in the embodiments illustrated balls are used as fixing elements 12360, 12361, the present invention is not limited to this case.

Alternatively, any fixing element 12360, 12361 having a not necessarily spherical shape can be used.

For example, cylindrical or drum-shaped rollers, meaning rollers with larger diameter at the centre than at the level of at least one of the peripheral areas, can be used as fixing elements 12360, 12361.

Alternatively, as shown for the fixing elements 15360C in FIG. 15, the fixing elements can have a substantially triangular shape.

More generally, it is sufficient for the fixing element 12360, 12361 to have at least one vertical wall forming an angle different from zero with respect to the rotation axis of the crank.

In other words, it is sufficient that the fixing element has a convex shape. This inclination of the at least one vertical wall of the fixing element allows the fixing element to slide into the respective concave cavity in the rotation seat when the fixing element is on the edge of the cavity.

It will thus be possible to use fixing elements in a substantially elliptical, triangular and/or generally polygonal shape, such as to allow the convex fixing element 12360, 12361 to slide into the respective concave seat, thus causing the precise positioning of the crank, as previously described.

Furthermore, even if the fixing elements 13260, 13261 have been described as elements that are separate from the crank, the present invention is not limited to this case.

For example, as illustrated in FIG. 15, the fixing elements 15360B can also be an integral part of the crank.

In addition to the above, it will be clear that even if according to the embodiments described herein the fixing elements are substantially integral with the crank while they move out of respective seats in the rotation seat, the present invention may also work in a symmetrical manner, that is, making the fixing elements substantially integral with the rotation seat and causing them to move out of respective seats in the crank.

Again in addition to the above, embodiments are possible in which some of the fixing elements are substantially integral with the crank while they move out of respective seats in the rotation seat and other fixing elements are substantially integral with the rotation seat while they move out of respective seats in the crank.

In the embodiments described above, only one position has been illustrated, in which the fixing elements 13260, 13261 enter the respective cavities 12352, 12353 in the rest position of the damped return device, or in any case in the closed condition of the door or window.

However, the present invention is not limited to this case. It will thus be possible to have fixing elements 13260, 13261 that enter the respective cavities 12352, 12353 in the open condition of the door or window. In addition or as an alternative to the above, it will be possible to provide several cavities 12352, 12353 in the seat 12350, so that the fixing elements enter respective cavities for different conditions of the door or window, for example the open condition, the closed condition, and more generally any condition of the door or window for which stability must be achieved through the interaction of the fixing elements 13260, 13261 with the cavities 12352, 12353. It will thus be clear that the number of fixing elements 13260, 13261 and of cavities 12352, 12353 need not be the same.

For example, it will be possible to have two fixing elements 13260, 13261 and four cavities 12352, 12353, in such a way as to define two conditions of the door or window in which the fixing elements 13260, 13261 interact with two respective cavities 12352, 12353.

Even if in the description provided above several embodiments have been illustrated independently of one another, in such a way as to make it easier to understand how they work, it will be clear to the expert in the art that the present invention is not limited to the individual embodiments described herein.

On the contrary, said embodiments and/or even only some characteristics of each embodiment can be combined with one another for the purpose of obtaining new embodiments of the present invention, as defined in the claims.

1.-9. (canceled)

10. An actuator for a damped return device, in particular for doors or windows, comprising:
a crank;
at least one fixing element;
a rotation seat of the crank, having at least one cavity in a shape substantially complementary to that of at least one part of the fixing element,
wherein the fixing element is positioned between the crank and the rotation seat,
characterized in that the crank comprises a connection element, for connecting the crank to a door or a window, and is configured so as to unload at least part of a weight acting on the connection element onto the rotation seat through the fixing element in at least one relative position of the crank and of the rotation seat, and in that the crank is configured so as to be lifted by the fixing element when the fixing element is not positioned in the cavity.

11. An actuator for a damped return device, in particular for doors or windows, comprising:
a crank;
a rotation seat of the crank;
at least one fixing element,
wherein the crank is provided with at least one cavity in a shape substantially complementary to that of at least one part of the fixing element,
wherein the fixing element is positioned between the crank and the rotation seat, characterized in that the crank comprises a connection element, for connecting the crank to a door or a window, and is configured so as to unload at least part of a weight acting on the connection element onto the rotation seat through the fixing element in at least one relative position of the crank and of the rotation seat, and in that the crank is configured so as to be lifted by the fixing element when the fixing element is not positioned in the cavity.

12. The actuator according to claim 11, wherein the fixing element is a sphere or a roller, possibly drum-shaped.

13. The actuator according to claim 11, wherein the fixing element has a triangular or generally polygonal cross section.

14. The actuator according to claim 11, wherein the fixing element is positioned in the cavity in a predetermined position of the actuator, preferably in the rest position of the actuator.

15. A damped return device, in particular for doors or windows, comprising:
an actuator according to claim 11;
a damping device activated by the actuator;
an elastic element configured in such a way as to bring the actuator back to a predetermined position, in the absence of a force exerted by the actuator.

16. A damped return device according to claim 15, wherein the actuator furthermore comprises a rod, and wherein the rod is configured in such a way as to move the damping device.
